(19) United States
(12) Patent Application Publication
(10) Pub. No.: US 2015/0253827 A1
(43) Pub. Date: Sep. 10, 2015

(54) CONTROL CIRCUIT OF SEMICONDUCTOR MEMORY, MEMORY SYSTEM AND CONTROL SYSTEM OF SEMICONDUCTOR MEMORY

(71) Applicant: Kabushiki Kaisha Toshiba, Minato-ku (JP)

(72) Inventor: Kosuke YANAGIDAIRA, Fujisawa-shi (JP)

(73) Assignee: Kabushiki Kaisha Toshiba, Minato-ku (JP)

(21) Appl. No.: 14/297,963

(22) Filed: Jun. 6, 2014

Related U.S. Application Data
(60) Provisional application No. 61/947,763, filed on Mar. 4, 2014.

(51) Int. Cl. G06F 1/26; G06F 1/32

(52) U.S. Cl. CPC G06F 1/26; G06F 1/3287

(57) ABSTRACT

A control circuit of a semiconductor memory controls the semiconductor memory and configures a memory system with the semiconductor memory. The memory system is supplied with power from a power supply. The memory system transits between a first state and a second state in which a load current of the memory system is different from each other. The control circuit is configured to receive a terminal voltage of the power supply as a first terminal voltage when the memory system is in the first state. The control circuit is configured to receive a terminal voltage of the power supply as a second terminal voltage when the memory system is in the second state. The control circuit is configured to judge whether a difference between the first terminal voltage and the second terminal voltage is larger than a certain value.

### CROSS-REFERENCE TO RELATED APPLICATIONS

This application is based upon and claims the benefit of U.S. Provisional Patent Application No. 61/947,763, filed on Mar. 4, 2014, the entire contents of which are incorporated herein by reference.

### FIELD

The embodiments described herein relate to a control circuit of a semiconductor memory, a memory system and a control system of the semiconductor memory.

### BACKGROUND

Recently, mobile devices such as smartphones or tablet-type terminals become popular rapidly. These mobile devices comprise: a memory system having a semiconductor memory and a control circuit that controls the semiconductor memory; a battery supplying power to the memory system; and a monitoring circuit that detects a terminal voltage of the battery.

### BRIEF DESCRIPTION OF THE DRAWINGS

FIG. 1 is a block diagram showing a configuration of a mobile device according to a first embodiment.

FIG. 2 is a circuit diagram showing a configuration of a part of the same mobile device.

FIG. 3 is a block diagram showing a configuration of a control circuit according to the same embodiment.

FIG. 4 is a block diagram showing a configuration of a memory interface according to the same embodiment.

FIG. 5 is a graph for explaining an operation of the mobile device according to the same embodiment.

FIG. 6 is a flowchart for explaining the operation of the same mobile device.

FIG. 7 is a block diagram showing a configuration of a mobile device according to a second embodiment.

FIG. 8 is a block diagram showing a configuration of a mobile device according to a third embodiment.

FIG. 9 is a block diagram showing a configuration of a mobile device according to a fourth embodiment.

FIG. 10 is a timing diagram for explaining an operation of the same mobile device.

FIG. 11 is a timing diagram for explaining the operation of the same mobile device.

FIG. 12 is a flowchart for explaining the operation of the same mobile device.

FIG. 13 is a block diagram showing a configuration of a mobile device according to a fifth embodiment.

FIG. 14 is a block diagram showing a configuration of a memory interface according to the same embodiment.

FIG. 15 is a flowchart for explaining an operation of the mobile device according to the same embodiment.

FIG. 16 is a block diagram showing a configuration of a mobile device according to a sixth embodiment.

FIG. 17 is a flowchart for explaining an operation of the mobile device according to the same embodiment.

FIG. 18 is a block diagram showing a configuration of a mobile device according to a seventh embodiment.

FIG. 19 is a block diagram showing a configuration of a mobile device according to a eighth embodiment.

FIG. 20 is a block diagram showing a configuration of a electronic device according to a ninth embodiment.

### DETAILED DESCRIPTION

A control circuit of a semiconductor memory according to following embodiments controls the semiconductor memory and configures a memory system with the semiconductor memory. The memory system is supplied with power from a power supply. The memory system transits between a first state and a second state in which a load current of the memory system is different from each other. The control circuit is configured to receive a terminal voltage of the power supply as a first terminal voltage when the memory system is in the first state. The control circuit is configured to receive a terminal voltage of the power supply as a second terminal voltage when the memory system is in the second state. The control circuit is configured to judge whether a difference between the first terminal voltage and the second terminal voltage is larger than a certain value.

Hereinafter, a semiconductor device, semiconductor memory device and a method of controlling the same according to embodiments are described with reference to the accompanying drawings.

### First Embodiment

### Configuration

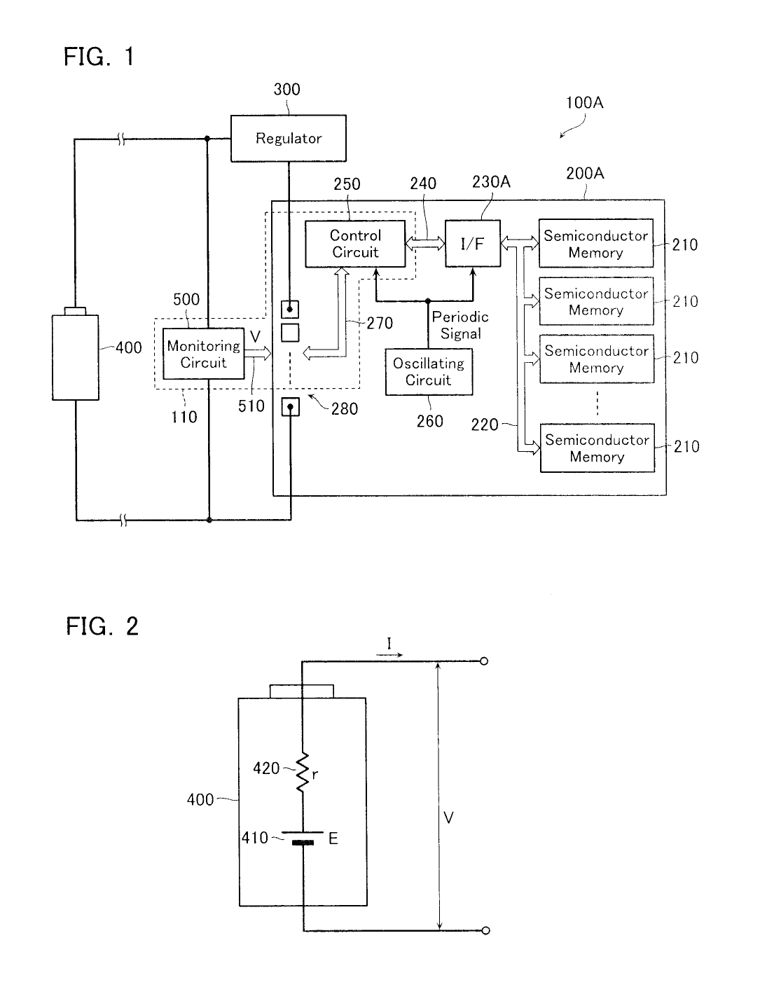

FIG. 1 is a block diagram showing a configuration of a mobile device 100A according to a first embodiment. The mobile device 100A is a device that is driven by being supplied with power from a battery 400. The mobile device 100A is, for example, a smartphone, a tablet-type terminal, a mobile phone, a portable music player, a portable video game player, a wearable terminal or the like. Furthermore, the mobile device 100A according to this embodiment comprises a memory system 200A, and controls a load current of the memory system 200A according to a state of the battery 400.

As shown in FIG. 1, the mobile device 100A comprises: a memory system 200A that stores data; a regulator 300 that regulates a voltage applied to the memory system 200A; a battery 400 that supplies power to the memory system 200A via the regulator 300; and a monitoring circuit 500 that detects a terminal voltage of the battery 400.

The memory system 200A according to this embodiment may be a detachable memory system such as, for example, a memory card. The memory system 200A according to this embodiment may also be a built-in memory chip. The memory system 200A stores data input via input/output pins 280 and outputs the stored data via the input/output pins 280. Furthermore, the memory system 200A is supplied with power via the input/output pins 280.

As shown in FIG. 1, the memory system 200A comprises: a plurality of semiconductor memories 210 that stores data; a control circuit 250 that controls the plurality of the semiconductor memories 210 in parallel; and a memory interface 230A that inputs commands output from the control circuit 250 to the plurality of the semiconductor memories 210. Furthermore, the memory system 200A comprises an oscillating circuit 260 that inputs periodic signal to the control circuit 250 and the memory interface 230A.

The semiconductor memory 210 is a memory that reads, writes, and erases data according to commands from the control circuit 250. The semiconductor memory 210 is, for example, a NAND flash memory, NOR flash memory, ReRAM (Resistive Random Access Memory), MRAM (Magnetoresistive Random Access Memory), DRAM (Dynamic Random Access Memory) or the like.

The control circuit 250 controls the plurality of the semiconductor memory 210 via the memory interface 230A and performs various operations like a writing operation of data, a reading operation of data, an erasing operation of data and a stand-by operation. Additionally, the control circuit 250 according to this embodiment is connected to the input/output pins 280 via a bus 270. Furthermore, the control circuit 250 forms, with the monitoring circuit 500, a control system 110 that controls the semiconductor memories 210.

The memory interface 230A stores commands output from the control circuit 250 temporarily, and inputs the stored commands to a certain semiconductor memory 210. The memory interface 230A is connected to the plurality of the semiconductor memories 210 via a bus 220, and is connected to the control circuit 250 via a bus 240.

The regulator 300 regulates the terminal voltage of the battery 400, generates a constant voltage having a certain value and supplies the generated voltage to the memory system 200A. The battery 400 is a battery such as a primary cell, a secondary cell, a fuel cell or the like.

The monitoring circuit 500 is, for example, a voltmeter. The monitoring circuit 500 is connected to the input/output pins 280 via a bus 510. The monitoring circuit 500 detects the terminal voltage of the battery 400 and inputs the detected terminal voltage to the memory system 200A via the bus 510.

FIG. 2 is a schematic circuit diagram for describing characteristics of the battery 400. The battery 400 can be assumed as a serial circuit of a DC (Direct Current) power supply 410 and an internal resistance 420. Hereinafter, an electromotive force of the DC power supply 410 is described as “E”, resistance value of the internal resistance 420 is described as “r”, a current supplied by the battery 400 is described as “I”, and the terminal voltage of the battery 400 is described as “V”.

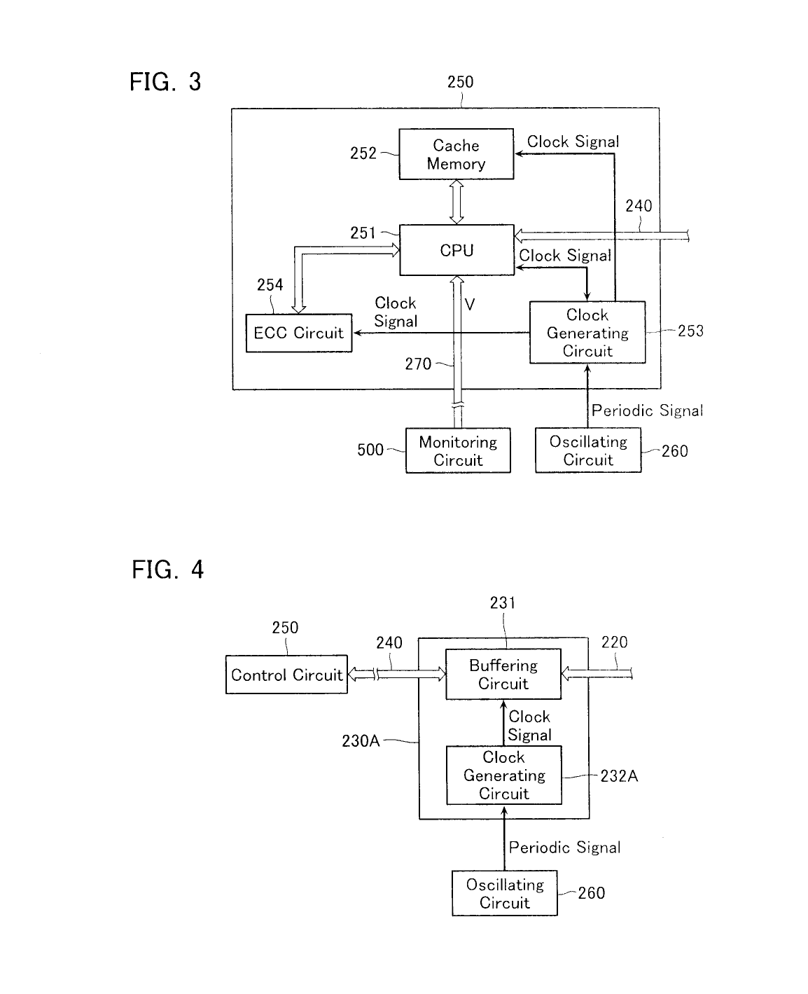

FIG. 3 is a block diagram showing a schematic configuration of a control circuit 250. The control circuit 250 comprises: a CPU (Central Processing Unit) 251 that performs an arithmetic processing; a cache memory 252; an ECC (Error Correcting Codes) circuit 254 that performs an error detection and a data correction; and a clock generating circuit 253 that inputs a clock signal to the CPU 251, the cache memory 252 and the ECC circuit 254.

The CPU 251 sequentially reads commands, addresses and data stored in the cache memory 252 and performs arithmetic processing. Additionally, the CPU 251 receives data concerning the terminal voltage V detected by the monitoring circuit 500 and controls the plurality of the semiconductor memories 210 using a method described below.

The clock generating circuit 253 is input with the periodic signal by the oscillating circuit 260, generates the clock signal and inputs the generated clock signal to the CPU 251, the cache memory 252 and the ECC circuit 254.

FIG. 4 is a block diagram showing a configuration of the memory interface 230A. The memory interface 230A comprises: a buffer circuit 231 that mediates a transfer between the control circuit 250 and the semiconductor memories 210; and a clock generating circuit 232A that inputs a clock signal to the buffer circuit 231.

The buffer circuit 231 is connected to the control circuit 250 via a bus 240 and connected to the plurality of the semiconductor memories 210 via a bus 220. The clock generating circuit 232A is input with the periodic signal by the oscillating circuit 260, generates the clock signal and inputs the generated clock signal to the buffer circuit 231.

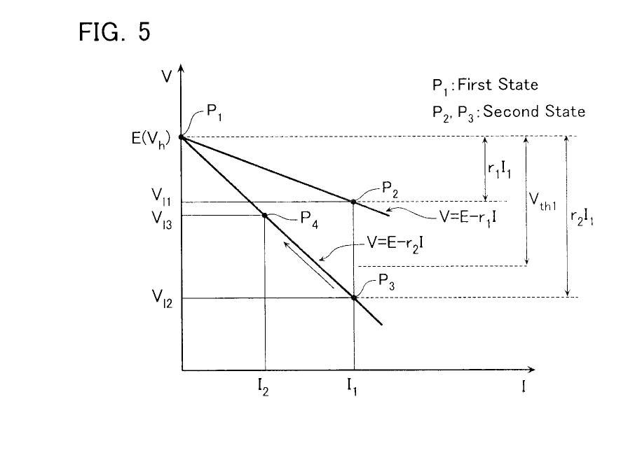

FIG. 5 is a graph for explaining an operation of the mobile device 100A. A vertical axis of the graph shows amplitude of the terminal voltage V of the battery 400. A horizontal axis of the graph shows amplitude of the current I supplied by the battery 400.

A “first state” described in FIG. 5 is a state in which a load of the memory system 200A is small and a load current is smaller than a certain value. The first state is, for example, a stand-by state. On the other hand, a “second voltage” described in FIG. 5 is a state in which a load of the memory system 200A is large and a load current is larger than the certain value. The first state is, for example, a state in which the writing operation is being performed, a state in which the erasing operation is being performed, or the like.

The terminal voltage V can roughly be described as “V=−rI”. Additionally, the resistance value r may increase by various reasons such as operational temperature, change in characteristics with time or the like. In FIG. 5, a relationship between the terminal voltage V and the current I when the resistance value is “r₁” and a relationship between the terminal voltage V and the current I when the resistance value is “r₂” (r₂>r₁) are described.

As shown in FIG. 5, when the resistance value r is “r” which is relatively small and when the memory system 200A is in the first state, operating point of the mobile device 100A becomes P₁ and the terminal voltage V becomes Vₕ which is close to the electromotive force E. On the other hand, when the resistance value r is “r₁” which is relatively small and when the memory system 200A is in the second state, operating point of the mobile device 100A becomes P₂ and the terminal voltage V becomes V₁₁=E−r₁ I₁.

On the other hand, when the resistance value r is “r₂” which is relatively large and when the memory system 200A is in the first state, operating point of the mobile device 100A becomes P₁ and the terminal voltage V becomes Vₕ which is close to the electromotive force E. On the other hand, when the resistance value r is “r₂” which is relatively large and when the memory system 200A is in the second state, operating point of the mobile device 100A becomes P₃ and the terminal voltage V becomes V₁₂=E−r₂I₁.

As described above, when the resistance value r becomes lager, the terminal voltage V can become smaller than a voltage needed for driving the memory system 200A.

Accordingly, as shown in FIG. 5, the control circuit 250 according to this embodiment calculates a difference between the terminal voltage in the first state and the terminal voltage in the second state. When the calculated value of the difference is larger than a threshold voltage Vₜₕ₁ which is set preliminarily, the control circuit 250 decreases the load of the memory system 200A and decreases the load current from I₁ to I₂. This makes the operating point of the mobile device 100A become P₄ and the terminal voltage V is increased from V₁₂ to V₁₃ (=E−r₂I₂). Therefore, the voltage needed for driving the memory system 200A is earned.

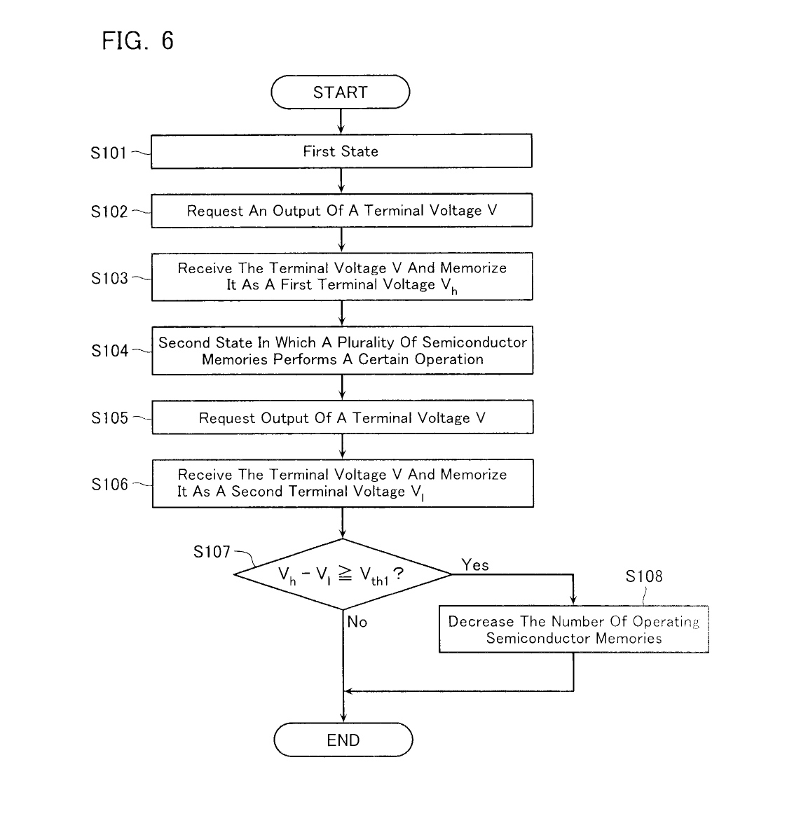

FIG. 6 is a flowchart for explaining the operation of the control circuit 250 according to this embodiment. At first, the control circuit 250 controls the semiconductor memories 210 so that the memory system 200A transits to the first state (Step S101).

Next, the control circuit 250 requests an output of the terminal voltage V to the monitoring circuit 500 (Step S102). Next, the control circuit 250 memorizes the terminal voltage V output from the monitoring circuit 500 as a first terminal voltage Vₕ (Step S103). The first terminal voltage Vₕ can be stored by, for example, the cache memory 252, the semiconductor memories 210 or the like.

Next, the control circuit 250 controls the plurality of the semiconductor memories 210 in parallel so as to make the semiconductor memories 210 to perform a certain operation, for example, the writing operation, erasing operation or the like. This causes the memory system 200A to transit to the second state (Step S104).

Next, the control circuit 250 requests the output of the terminal voltage V to the monitoring circuit 500 (Step S105). Next, the control circuit 250 memorizes the terminal voltage V output from the monitoring circuit 500 as a second terminal voltage (Step S106). The second terminal voltage V₁ can be stored by, for example, the cache memory 252, the semiconductor memories 210 or the like.

Next, the control circuit 250 reads the stored first terminal voltage Vₕ and the stored second voltage V₁, calculates the difference between these voltages Vₕ−V₁ and judges whether the difference Vₕ−V₁ is larger than or equal to the threshold voltage Vₜₕ₁ (Step S107). If the difference Vₕ−V₁ is larger than or equal to the threshold voltage Vₜₕ₁, the control circuit 250 decreases the number of operating semiconductor memories 210 (Step S108). If the difference Vₕ−V₁ is smaller than the threshold voltage Vₜₕ₁, the control circuit 250 does not perform the operation of the step S108 and does not change the number of operating semiconductor memories 210.

As described above, the control circuit 250 according to this embodiment detects the state of the battery 400 and adjusts the number of operating semiconductor memories 210 nicely according to results of the detection. Therefore, when the resistance value r is small, the control circuit 250 increases the number of operating semiconductor memories 210 in parallel in the mobile device 100A so as to earn high-performance. Additionally, when the resistance value r is large, the control circuit 250 decreases the number of operating semiconductor memories 210 in parallel in the mobile device 100A so as to decrease the load current and to earn the voltage needed for driving the memory system 200A.

### Second Embodiment

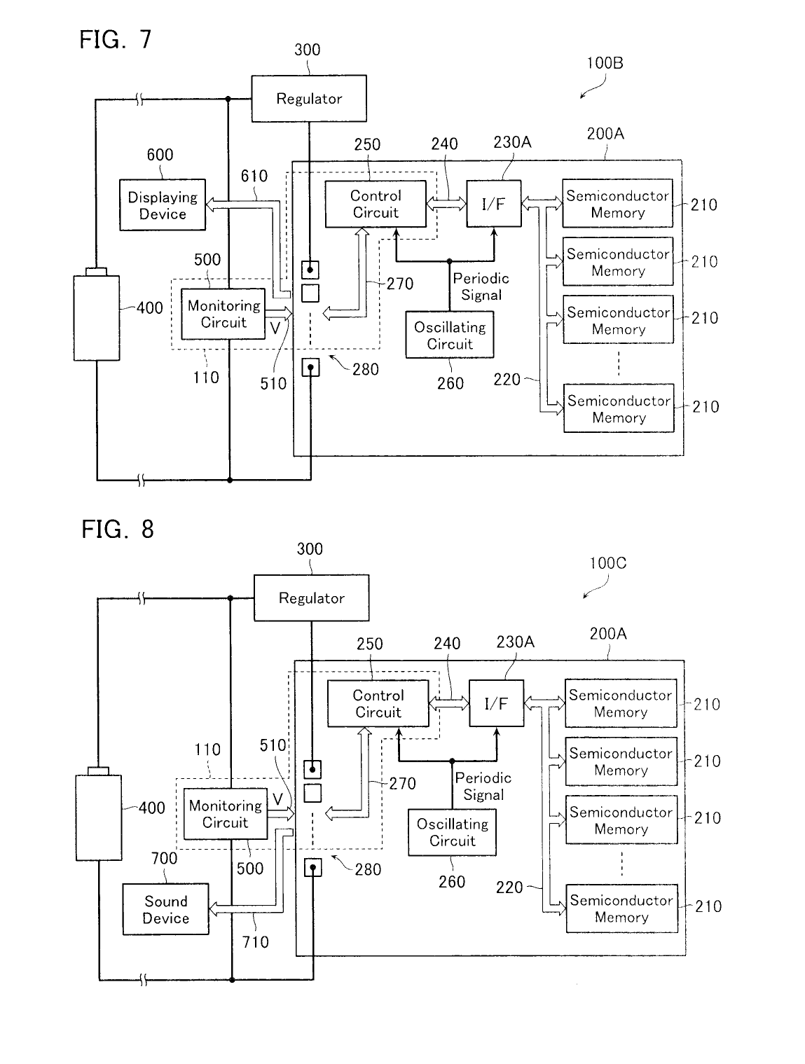

Next, a second embodiment will be described with reference to FIG. 7. FIG. 7 is a block diagram showing a configuration of a mobile device 100B according to the second embodiment. Note that configurations in FIG. 7 same as configurations of the mobile device 100A according to the first embodiment are referred to by the same numerals as the configurations according to the first embodiment and descriptions of these configurations are omitted. The mobile device 100B according to this embodiment comprises a displaying device 600 and lets users know the change in an operation speed of the mobile device 100B using the displaying device 600.

The displaying device 600 is a device that indicates data output from the memory system 200A. The displaying device 600 is, for example, liquid crystal display, LED (Light Emitting Diode) indicator, miniature bulb or the like. The displaying device 600 is connected to the input/output pins 280 of the memory system 200A via a bus 610.

In the step S108 described above, the control circuit 250 according to this embodiment not only decreases the number of the operating semiconductor memories 210, but also inputs a certain signal to the displaying device 600.

The displaying device 600 indicates the change in the number of the operating semiconductor memories 210 and the like according to the input of the certain signal. Therefore, the users can know the change in the operation speed of the mobile device 100B via an indication of the displaying device 600. Additionally, it is also possible to urge the users to exchange or charge of the battery 400.

### Third Embodiment

Next, a third embodiment will be described with reference to FIG. 8. FIG. 8 is a block diagram showing a configuration of a mobile device 100C according to the third embodiment. Note that configurations in FIG. 8 same as configurations of the mobile device 100A according to the first embodiment are referred to by the same numerals as the configurations according to the first embodiment and descriptions of these configurations are omitted. The mobile device 100C according to this embodiment comprises a sound device 700 and lets users know the change in an operation speed of the mobile device 100C using the sound device 700.

The sound device 700 is a device that outputs a sound according to data output from the memory system 200A. The sound device 700 is, for example, earphone, speaker or the like. The sound device 700 is connected to the input/output pins 280 of the memory system 200A via a bus 710.

In the step S108 described above, the control circuit 250 according to this embodiment not only decreases the number of the operating semiconductor memories 210, but also inputs a certain signal to the sound device 700.

The sound device 700 outputs a sound showing the change in the number of the operating semiconductor memories 210 and the like according to the input of the certain signal. Therefore, the users can know the change in the operation speed of the mobile device 100C via the sound output from the sound device 700. Additionally, it is also possible to urge the users to exchange or charge of the battery 400.

### Fourth Embodiment

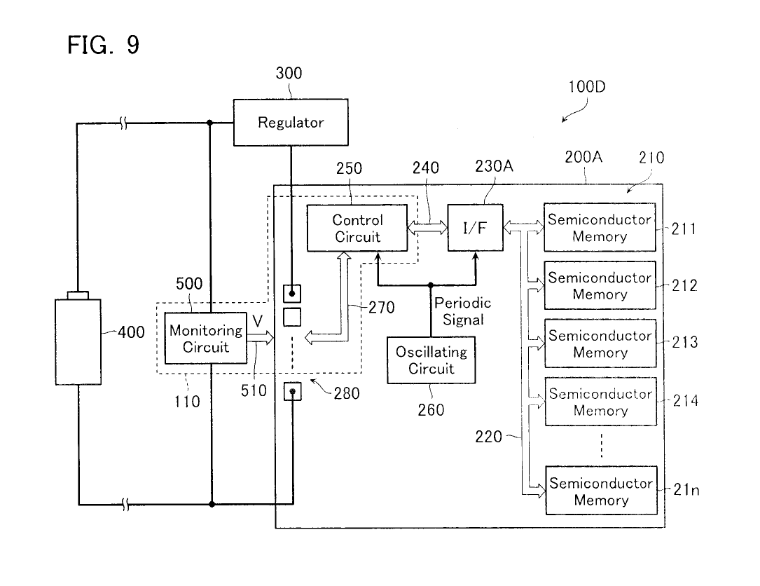

Next, a fourth embodiment will be described with reference to FIG. 9 to FIG. 12. FIG. 9 is a block diagram showing a configuration of a mobile device 100D according to the fourth embodiment. Note that configurations in FIG. 9 same as configurations of the mobile device 100A according to the first embodiment are referred to by the same numerals as the configurations according to the first embodiment and descriptions of these configurations are omitted.

The mobile device 100D is configured to be able to perform the writing operation, reading operation or the erasing operation to the plurality of the semiconductor memories 210 by so-called “an interleave operation”. The mobile device 100D is different from the mobile devices according to embodiments described above in this point. The mobile device 100D controls the semiconductor memories 210 by the interleave operation according to the result of detecting of the monitoring circuit 500. In other points, the mobile device 100D according to this embodiment is configured similarly to the mobile device 100A according to the first embodiment. Note that the plurality of the semiconductor memories 210 are referred to by various numerals 211-214 and 21n in FIG. 9 for convenience of description.

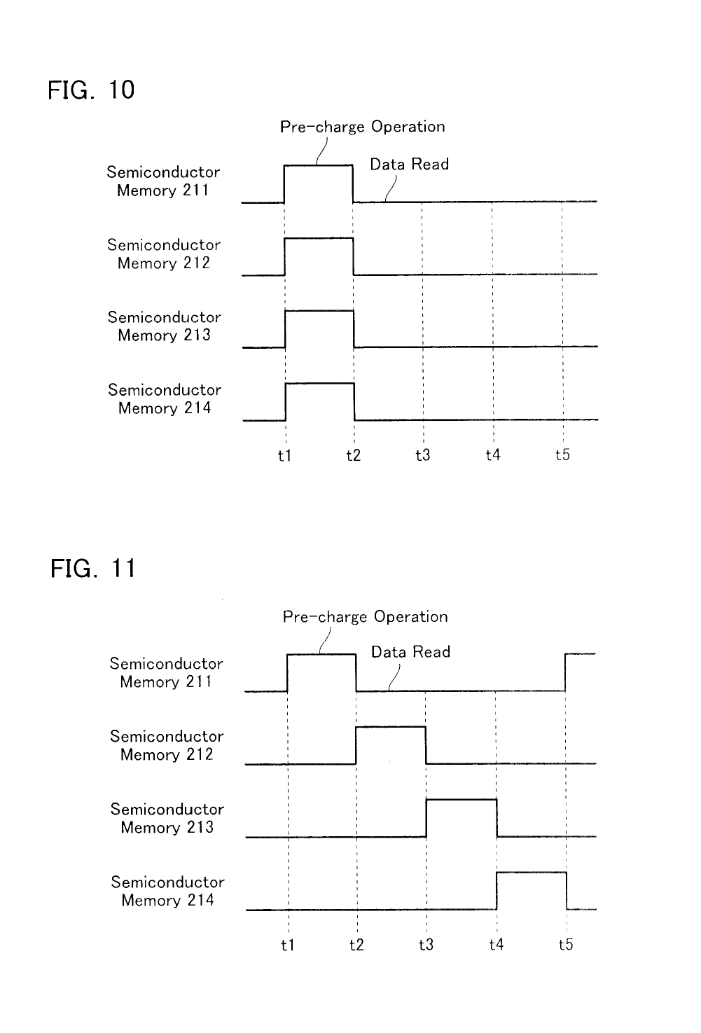

Next, a normal operation and the interleave operation is described with reference to FIG. 10 and FIG. 11. FIG. 10 and FIG. 11 are timing diagrams for describing the normal operation and the interleave operation.

FIG. 10 shows enable signals when the four semiconductor memories 211-214 are performing the reading operation. As shown in FIG. 10, the enable signals input to the semiconductor memories 211-214 become H state at the same time. The semiconductor memories 211-214 start a pre-charge operation when the enable signals input to the semiconductor memories 211-214 become H state. The semiconductor memories 211-214 start reading stored data when the enable signals input to the semiconductor memories 211-214 become L state.

FIG. 11 shows enable signals when the four semiconductor memories 211-214 are performing the reading operation by the interleave operation. As shown in FIG. 11, the enable signals input to the semiconductor memories 211-214 become H state in turn. The semiconductor memories 211-214 start the pre-charge operation when the enable signals input to the semiconductor memories 211-214 become H state. The semiconductor memories 211-214 start reading the stored data when the enable signals input to the semiconductor memories 211-214 become L state.

That is, at a timing “t1”, an enable signal input to the semiconductor memory 211 becomes H state. According to this, the semiconductor memory 211 starts the pre-charge operation.

At a timing “t2”, the enable signal input to the semiconductor memory 211 becomes L state. According to this, the semiconductor memory 211 starts reading the stored data. Additionally, at the timing “t2”, an enable signal input to the semiconductor memory 212 becomes H state. According to this, the semiconductor memory 212 starts the pre-charge operation.

At a timing “t3”, the enable signal input to the semiconductor memory 212 becomes L state. According to this, the semiconductor memory 212 starts reading the stored data. Additionally, at the timing “t3”, an enable signal input to the semiconductor memory 213 becomes H state. According to this, the semiconductor memory 213 starts the pre-charge operation.

By using the interleave operation, timings of the pre-charge operation in which the load current increases instantaneously are varied between the plurality of the semiconductor memories 211-214 and it is possible to prevent the load current from increasing instantaneously in the memory system 200A. Additionally, the pre-charge operation is concealed substantially and hence the operation time is reduced substantially.

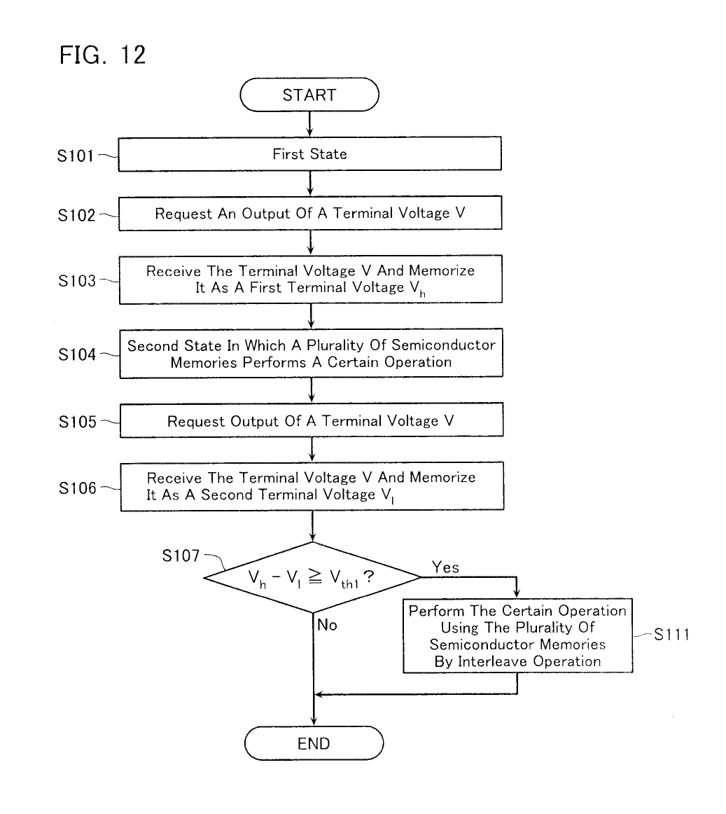

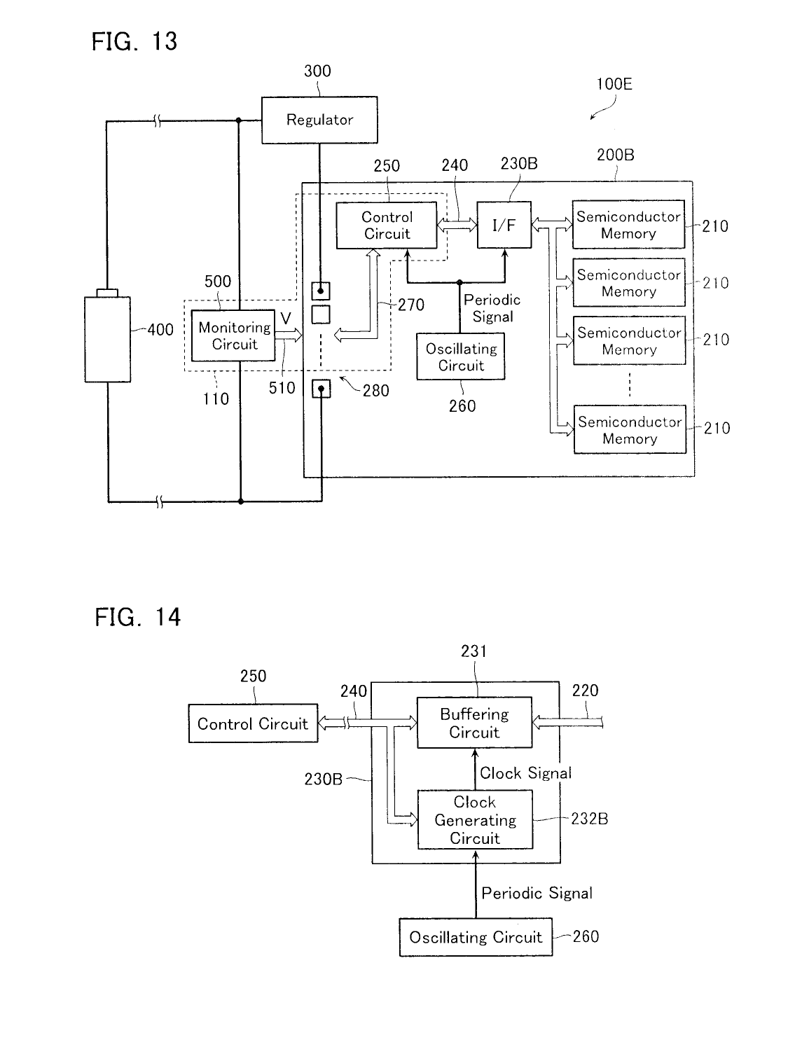

Next, the operation of the control circuit 250 according to this embodiment is described with reference to FIG. 12. FIG. 12 is a flowchart for explaining the operation of the control circuit 250 according to this embodiment. At first, the control circuit 250 controls the semiconductor memories 210 so that the memory system 200A transits to the first state (Step S101).

Next, the control circuit 250 requests an output of the terminal voltage V to the monitoring circuit 500 (Step S102). Next, the control circuit 250 memorizes the terminal voltage V output from the monitoring circuit 500 as a first terminal voltage Vₕ (Step S103). The first terminal voltage Vₕ can be stored by, for example, the cache memory 252, the semiconductor memories 210 or the like.

Next, the control circuit 250 controls the plurality of the semiconductor memories 210 in parallel so as to make the semiconductor memories 210 to perform a certain operation, for example, the writing operation, erasing operation or the like so that the memory system 200A transits to the second state (Step S104).

Next, the control circuit 250 requests the output of the terminal voltage V to the monitoring circuit 500 (Step S105). Next, the control circuit 250 memorizes the terminal voltage V output from the monitoring circuit 500 as a second terminal voltage V₁ (Step S106). The second terminal voltage V₁ can be stored by, for example, the cache memory 252, the semiconductor memories 210 or the like.

Next, the control circuit 250 reads the stored first terminal voltage Vₕ and the stored second voltage V₁, calculates the difference between these voltages Vₕ−V₁ and judges whether the difference Vₕ−V₁ is larger than or equal to the threshold voltage Vₜₕ₁ (Step S107). If the difference Vₕ−V₁ is larger than or equal to the threshold voltage Vₜₕ₁, the control circuit 250 makes the plurality of semiconductor memories 210 to performs a certain operation, for example, the pre-charge operation by the interleave operation (Step S111). If the difference Vₕ−V is smaller than the threshold voltage Vₜₕ₁, the control circuit 250 does not perform the operation of the step S111 and does not perform the interleave operation.

As described above, the control circuit 250 according to this embodiment detects the state of the battery 400 and performs the interleave operation according to results of the detection. Therefore, when the resistance value r is small, the control circuit 250 makes the plurality of the semiconductor memories 210 to perform the certain operation at the same time in the mobile device 100D so as to earn high-performance. Additionally, when the resistance value r is large, the control circuit 250 prevents instantaneous increases of the load current from occurring by performing the interleave operation in the mobile device 100D so as to earn the voltage needed for driving the memory system 200A.

### Fifth Embodiment

Next, a fifth embodiment will be described with reference to FIG. 13 to FIG. 15. FIG. 13 is a block diagram showing a configuration of a mobile device 100E according to the fifth embodiment. Note that configurations in FIG. 13 same as configurations of the mobile device 100A according to the first embodiment are referred to by the same numerals as the configurations according to the first embodiment and descriptions of these configurations are omitted. The mobile device 100E according to this embodiment decreases a drive frequency of a memory interface 230B so as to adjust the amplitude of the current I.

As shown in FIG. 13, the mobile device 100E according to this embodiment comprises a memory system 200B having the memory interface 230B of which the drive frequency can be adjusted. In other points, the mobile device 100E is configured similarly to the mobile device 100A according to the first embodiment.

FIG. 14 is a block diagram showing a configuration of the memory interface 230B. Note that configurations in FIG. 14 same as configurations of the memory interface 230A according to the first embodiment are referred to by the same numerals as the configurations according to the first embodiment and descriptions of these configurations are omitted. The memory interface 230B is basically configured similarly to the memory interface 230A according to the first embodiment. However, a configuration of a clock generating circuit 232B is different from the configuration of the clock generating circuit 232A according to the first embodiment. That is, the clock generating circuit 232B is connected to the control circuit 250 via the bus 240 and generates clock signals having various frequencies according to commands from the control circuit 250.

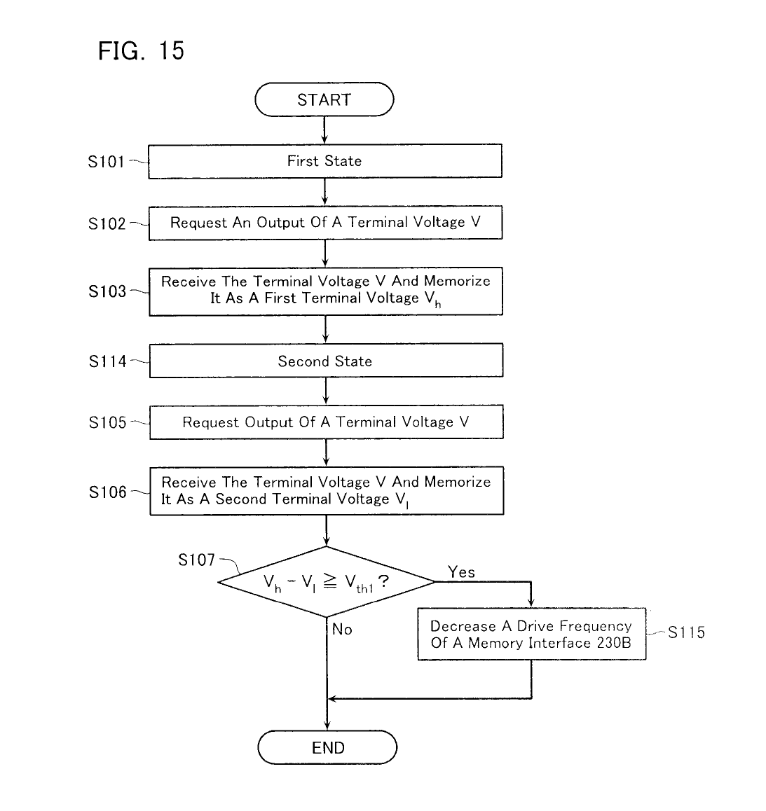

FIG. 15 is a flowchart for explaining an operation of the mobile device 100E according to this embodiment. At first, the control circuit 250 controls the semiconductor memories 210 so that the memory system 200B transits to the first state (Step S101).

Next, the control circuit 250 requests an output of the terminal voltage V to the monitoring circuit 500 (Step S102). Next, the control circuit 250 memorizes the terminal voltage V output from the monitoring circuit 500 as a first terminal voltage Vₕ (Step S103). The first terminal voltage Vₕ can be stored by, for example, the cache memory 252, the semiconductor memories 210 or the like.

Next, the control circuit 250 makes the semiconductor memory 210 to perform the certain operation so that the memory system 200B transits to the second state (Step S114).

Next, the control circuit 250 requests the output of the terminal voltage V to the monitoring circuit 500 (Step S105). Next, the control circuit 250 memorizes the terminal voltage V output from the monitoring circuit 500 as a second terminal voltage V₁ (Step S106). The second terminal voltage V₁ can be stored by, for example, the cache memory 252, the semiconductor memories 210 or the like.

Next, the control circuit 250 reads the stored first terminal voltage Vₕ and the stored second voltage V₁, calculates the difference between these voltages Vₕ−V₁ and judges whether the difference Vₕ−V₁ is larger than or equal to the threshold voltage Vₜₕ₁ (Step S107). If the difference Vₕ−V₁ is larger than or equal to the threshold voltage Vₜₕ₁, the control circuit 250 controls the clock generating circuit 232B via the bus 240 so as to adjust the frequency of the clock signal. By this adjustment, the control circuit 250 decreases the drive frequency of the memory interface 230B (Step S115). If the difference Vₕ−V₁ is smaller than the threshold voltage Vₜₕ₁, the control circuit 250 does not perform the operation of the step S115 and does not adjust the frequency of the clock signal. Therefore, the drive frequency of the memory interface 230B is not adjusted.

As described above, the control circuit 250 according to this embodiment detects the state of the battery 400 and adjusts the drive frequency of the memory interface 230B nicely according to results of the detection. Therefore, when the resistance value r is small, the control circuit 250 increases the drive frequency of the memory interface 230B so as to earn high-performance. Additionally, when the resistance value r is large, the control circuit 250 decreases the drive frequency of the memory interface 230B so as to earn the voltage needed for driving the memory system 200B.

### Sixth Embodiment

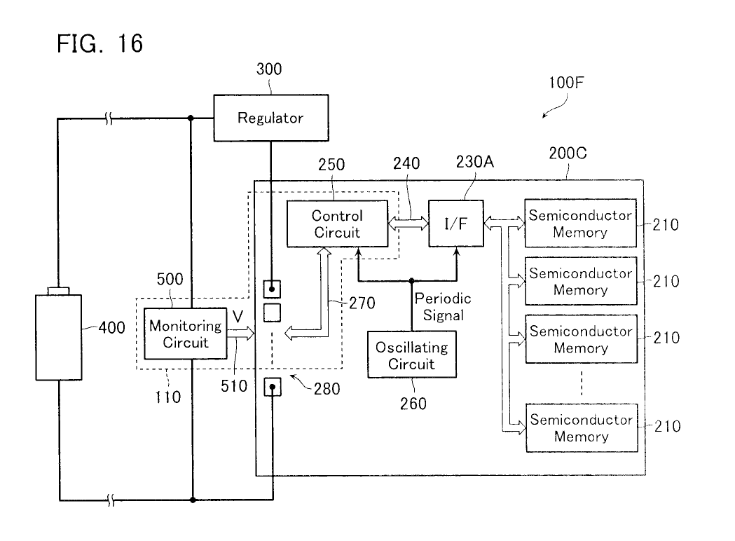

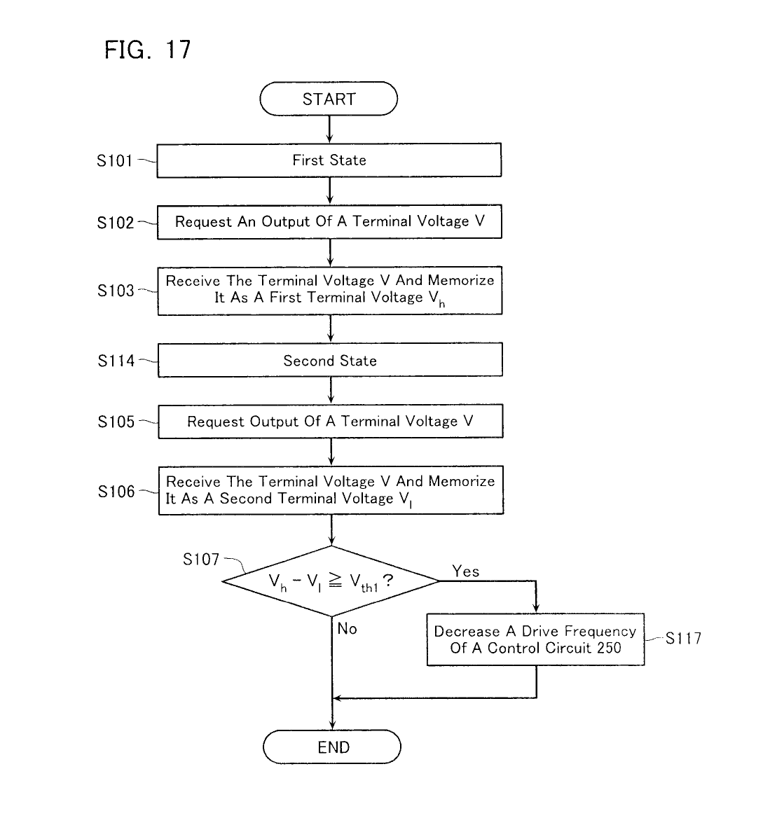

Next, a sixth embodiment will be described with reference to FIG. 16 and FIG. 17. FIG. 16 is a block diagram showing a configuration of a mobile device 100F according to the sixth embodiment. Note that configurations in FIG. 16 same as configurations of the mobile device 100A according to the first embodiment are referred to by the same numerals as the configurations according to the first embodiment and descriptions of these configurations are omitted. The mobile device 100F according to this embodiment adjusts a drive frequency of the control circuit 250 so as to adjust the current I.

As shown in FIG. 16, the mobile device 100F is basically configured similarly to the mobile device 100A according to the first embodiment.

FIG. 17 is a flowchart for explaining an operation of the mobile device 100F according to this embodiment. The mobile device 100F according to this embodiment operates basically similarly to the mobile device 100E according to the fifth embodiment. However, the mobile device 100F adjusts the drive frequency of the control circuit 250 so as to adjust the current I and is different from the mobile device 100E at this point.

That is, if the difference Vₕ−V₁ is larger than or equal to the threshold voltage Vₜₕ₁, the control circuit 250 controls the clock generating circuit 253 (FIG. 3) so as to adjust the frequency of the clock signal. By this adjustment, the control circuit 250 decreases the drive frequency of the control circuit 250 (Step S117). If the difference Vₕ−V₁ is smaller than the threshold voltage Vₜₕ₁, the control circuit 250 does not perform the operation of the step S117 and does not adjust the frequency of the clock signal. Therefore, the drive frequency of the control circuit 250 is not adjusted.

As described above, the control circuit 250 according to this embodiment detects the state of the battery 400 and adjusts the drive frequency of the control circuit 250 nicely according to results of the detection. Therefore, when the resistance value r is small, the memory control circuit 250 increases the drive frequency of the control circuit 250 so as to earn high-performance. Additionally, when the resistance value r is large, the control circuit 250 decreases the drive frequency of the control circuit 250 so as to earn the voltage needed for driving the memory system 200C.

### Seventh Embodiment

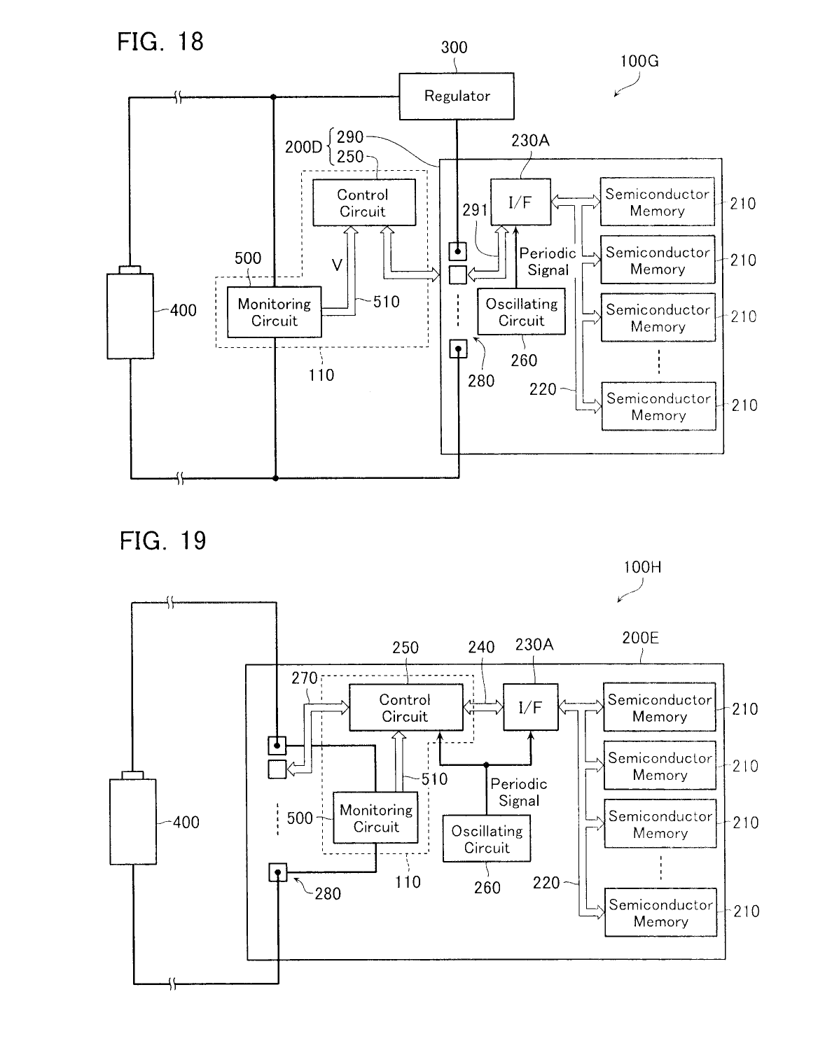

Next, a seventh embodiment will be described with reference to FIG. 18. FIG. 18 is a block diagram showing a configuration of a mobile device 100G according to the seventh embodiment. Note that configurations in FIG. 18 same as configurations of the mobile device 100A according to the first embodiment are referred to by the same numerals as the configurations according to the first embodiment and descriptions of these configurations are omitted. In this embodiment, a memory portion 290 comprising the semiconductor memories 210 and the control circuit 250 are supplied independently from each other. The memory portion 290 and the control circuit 250 form a memory system 200D. Note that the mobile device 100G is basically configured similarly to the mobile device 100A according to the first embodiment in other configurations.

The memory portion 290 according to this embodiment may be a detachable configuration. The memory portion 290 according to this embodiment may also be a memory chip. The memory portion 290 stores data input via input/output pins 280 and outputs the stored data via the input/output pins 280. Furthermore, the memory portion 290 is supplied with power via the input/output pins 280.

As shown in FIG. 18, the memory portion 290 comprises: a plurality of semiconductor memories 210 that stores data; and a memory interface 230A that is connected to the input/output pins 280 via a bus 291 and that inputs commands input via the input/output pins 280 to the plurality of the semiconductor memories 210. Furthermore, the memory portion 290 comprises an oscillating circuit 260 that inputs periodic signal to the memory interface 230A.

The control circuit 250 controls the memory system 200D using at least one method described in the first embodiment to the sixth embodiment.

In a case that the memory portion 290 and the control circuit 250 are supplied independently like this embodiment, high-performance is also earned when the resistance value r is small and the voltage needed for driving the memory system 200D is also earned when the resistance value r is large.

### Eighth Embodiment

Next, an eighth embodiment will be described with reference to FIG. 19. FIG. 19 is a block diagram showing a configuration of a mobile device 100H according to the eighth embodiment. Note that configurations in FIG. 19 same as configurations of the mobile device 100A according to the first embodiment are referred to by the same numerals as the configurations according to the first embodiment and descriptions of these configurations are omitted. In this embodiment, the monitoring circuit 500 is involved in a memory system 200E and is connected to the control circuit 250 via the bus 510. Additionally, the monitoring circuit 500 detects a voltage applied to the input/output pins 280. Note that although a regulator is not shown in FIG. 19, mobile device 100H may comprises the regulator. Note that the mobile device 100H is basically configured similarly to the mobile device 100A according to the first embodiment in other configurations.

The control circuit 250 controls the memory system 200E using at least one method described in the first embodiment to the sixth embodiment.

In a case that the monitoring circuit 500 is involved in the memory system 200E, high-performance is also earned when the resistance value r is small and the voltage needed for driving the memory system 200E is also earned when the resistance value r is large.

### Ninth Embodiment

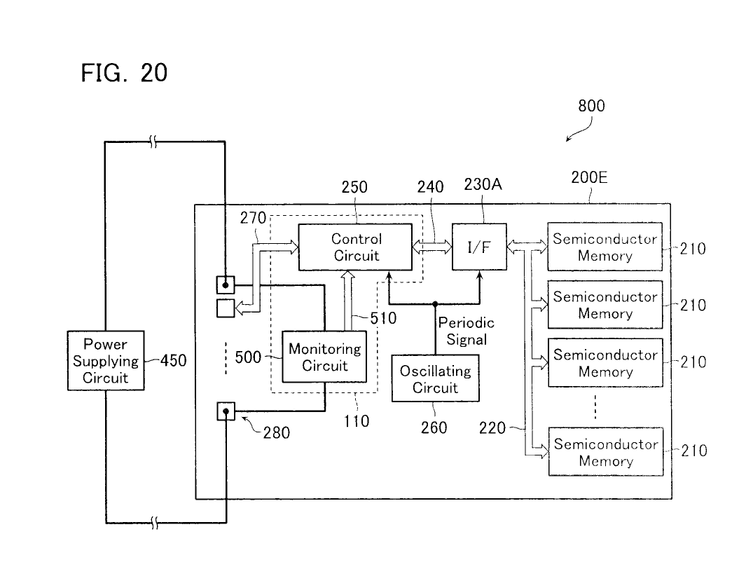

Next, a ninth embodiment will be described with reference to FIG. 20. FIG. 20 is a block diagram showing a configuration of an electronic device 800 according to the ninth embodiment. Note that configurations in FIG. 20 same as configurations of the mobile device 100A according to the first embodiment or the mobile device 100H according to the eighth embodiment are referred to by the same numerals as the configurations according to the first or the eighth embodiment and descriptions of these configurations are omitted.

The electronic device 800 is a device that is driven by being supplied with power from an external power supplying circuit 450. The electronic device 800 may be a mobile device which can also be driven by being supplied with power from a battery built in the electronic device 800 as described below. The electronic device 800 may also be an electronic device which needs to be supplied with power from external for driving, for example, an electronic device connected to a PC (Personal Computer) or the like. The power supplying circuit 450 is, for example, an electric circuit such as an AC (Alternating Current) adaptor or a DC-DC converter or a device which can supply power to external such as PC or the like. Furthermore, the electronic device 800 according to this embodiment comprises a memory system 200E having the monitoring circuit 500 and controls a load current of the memory system 200E according to a state, capacity or the like of the power supplying circuit 450. The memory system 200E according to this embodiment is, for example, a memory system which is supplied with power from an USB (Universal Serial Bus) terminal connected to an external PC or the like as the power supplying circuit 450. The memory system 200E is a memory system such as a SSD (Solid State Drive) or the like.

The control circuit 250 controls the memory system 200E using at least one method described in the first embodiment to the sixth embodiment.

The power supplying circuit 450 can be assumed as a serial circuit such as the serial circuit shown in FIG. 2 similarly to the battery 400 according to the first embodiment. That is, the power supplying circuit 450 has an internal resistance. Therefore, when the load current of the memory system 200E is increased, a voltage drop in the power supplying circuit 450 can be increased and the terminal voltage of the power supplying circuit 450 can become smaller than a voltage needed for driving the memory system 200E. In a case like this, by performing the method described in the first embodiment to the sixth embodiment, high-performance is also earned when the capacity of the electric circuit 450 is enough and the voltage needed for driving the memory system 200E is also earned when the capacity of the electric circuit 450 is not enough.

### OTHER EMBODIMENTS

It is possible to apply the displaying device 600 shown in the second embodiment or the sound device 700 shown in the third embodiment to the mobile devices according to the third to the ninth embodiment. Additionally, the memory systems according to the fifth to the ninth embodiment can be configured to have only one semiconductor memory 210. Furthermore, the drive frequency of the control circuit 250 and the frequency of the memory interface 230B can be controlled independently from or dependently on each other.

Additionally, as described above, the resistance value of the internal resistance r of the battery 400 can be increased according to increase of operational temperature. In the embodiments described above, the load current of the memory systems is decreased when the increase of the resistance value of the internal resistance r is occurred. Therefore, for example, if the resistance value of the internal resistance r is decreased according to decrease of the operational temperature, it is possible to increase the load current of the memory system again so as to perform high-speed operation.

Additionally, the first terminal voltage Vₕ and the second terminal voltage V₁ can be earned independently from each other. For example, the first terminal voltage Vₕ can be earned when the mobile devices are turned on or earned at every certain time interval. Additionally, the second voltage V₁ can be earned at every timing when a certain operation is performed. Furthermore, the first terminal voltage Vₕ and the second terminal voltage V, can be compared while the certain operation is performed. The load current can be controlled while the certain operation is performed, too.

### OTHERS

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control circuit of a semiconductor memory that controls the semiconductor memory and that configures a memory system with the semiconductor memory, wherein
the memory system is supplied with power from a power supply, and transits between a first state and a second state in which a load current of the memory system is different from each other, and
the control circuit is configured to receive a terminal voltage of the power supply as a first terminal voltage when the memory system is in the first state, receive a terminal voltage of the power supply as a second terminal voltage when the memory system is in the second state, and judge whether a difference between the first terminal voltage and the second terminal voltage is larger than a certain value.

2. The control circuit of the semiconductor memory according to claim 1, wherein,
the control circuit controls a plurality of the semiconductor memories in parallel, and performs a control so as to decrease the number of operating semiconductor memories when the difference between the first terminal voltage and the second terminal voltage is larger than the certain value.

3. The control circuit of the semiconductor memory according to claim 1, wherein,
the control circuit controls a plurality of the semiconductor memories in parallel, and is configured to be able to perform an interleave operation, the interleave operation performing a first operation to one semiconductor memory of the plurality of the semiconductor memories while performing a second operation to a semiconductor memory other than the one semiconductor memory, and when the first operation is finished, performing the first operation to another semiconductor memory of the plurality of the semiconductor memories while performing a second operation to a semiconductor memory other than the another semiconductor memory,
the control circuit performs the first operation to the plurality of the semiconductor memories in parallel when the difference between the first terminal voltage and the second terminal voltage is smaller than the certain value, and operates the plurality of the semiconductor memories by the interleave operation when the difference between the first terminal voltage and the second terminal voltage is larger than the certain value.

4. The control circuit of the semiconductor memory according to claim 1, wherein,
the control circuit controls the semiconductor memory via a memory interface and performs a control so as to decrease a drive frequency of the memory interface when the difference between the first terminal voltage and the second terminal voltage is larger than the certain value.

5. The control circuit of the semiconductor memory according to claim 1, wherein,
the control circuit performs a control so as to decrease a drive frequency of the control circuit when the difference between the first terminal voltage and the second terminal voltage is larger than the certain value.

6. The control circuit of the semiconductor memory according to claim 1, wherein,
the control circuit further controls a displaying device, and performs a control so as to input a certain signal to the displaying device when the difference between the first terminal voltage and the second terminal voltage is larger than the certain value.

7. The control circuit of the semiconductor memory according to claim 1, wherein,
the control circuit further controls a sound device, and performs a control so as to input a certain signal to the sound device when the difference between the first terminal voltage and the second terminal voltage is larger than the certain value.

8. A memory system comprising a semiconductor memory and a control circuit that controls the semiconductor memory, wherein
the memory system is supplied with power from a power supply, and transits between a first state and a second state in which a load current of the memory system is different from each other, and
the control circuit is configured to receive a terminal voltage of the power supply as a first terminal voltage when the memory system is in the first state, receive a terminal voltage of the power supply as a second terminal voltage when the memory system is in the second state, and judge whether a difference between the first terminal voltage and the second terminal voltage is larger than a certain value.

9. The memory system according to claim 8, wherein,
the memory system comprises a plurality of semiconductor memories and the control circuit controls the plurality of the semiconductor memories in parallel, and, the control circuit performs a control so as to decrease the number of operating semiconductor memories when the difference between the first terminal voltage and the second terminal voltage is larger than the certain value.

10. The memory system according to claim 8, wherein,
the memory system comprises a plurality of semiconductor memories, the control circuit controls the plurality of the semiconductor memories in parallel, and the control circuit is configured to be able to perform an interleave operation, the interleave operation performing a first operation to one semiconductor memory of the plurality of the semiconductor memories while performing a second operation to a semiconductor memory other than the one semiconductor memory, and when the first operation is finished, performing the first operation to another semiconductor memory of the plurality of the semiconductor memories while performing a second operation to a semiconductor memory other than the another semiconductor memory,
the control circuit performs the first operation to the plurality of the semiconductor memories in parallel when the difference between the first terminal voltage and the second terminal voltage is smaller than the certain value, and operates the plurality of the semiconductor memories by the interleave operation when the difference between the first terminal voltage and the second terminal voltage is larger than the certain value.

11. The memory system according to claim 8, wherein,
the memory system further comprises a memory interface, and
the control circuit controls the semiconductor memory via the memory interface, and performs a control so as to decrease a drive frequency of the memory interface when the difference between the first terminal voltage and the second terminal voltage is larger than the certain value.

12. The memory system according to claim 8, wherein,
the control circuit performs a control so as to decrease a drive frequency of the control circuit when the difference between the first terminal voltage and the second terminal voltage is larger than the certain value.

13. The memory system according to claim 8, wherein,
the control circuit further controls a displaying device, and performs a control so as to input a certain signal to the displaying device when the difference between the first terminal voltage and the second terminal voltage is larger than the certain value.

14. The memory system according to claim 8, wherein,
the control circuit further controls a sound device, and performs a control so as to input a certain signal to the sound device when the difference between the first terminal voltage and the second terminal voltage is larger than the certain value.

15. A control system of a semiconductor memory, wherein
the control system comprises a control circuit of the semiconductor memory that controls the semiconductor memory and that configures a memory system with the semiconductor memory, and a monitoring circuit that detects a terminal voltage of a power supply that supplies power to the memory system,
the memory system transits between a first state and a second state in which a load current of the memory system is different from each other,
the control circuit is configured to receive the terminal voltage of the power supply as a first terminal voltage when the memory system is in the first state, receive the terminal voltage of the power supply as a second terminal voltage when the memory system is in the second state, and judge whether a difference between the first terminal voltage and the second terminal voltage is larger than a certain value.

16. The control system of the semiconductor memory according to claim 15, wherein,
the control circuit controls a plurality of the semiconductor memories in parallel, and performs a control so as to decrease the number of operating semiconductor memories when the difference between the first terminal voltage and the second terminal voltage is larger than the certain value.

17. The control system of the semiconductor memory according to claim 15, wherein,
the control circuit controls a plurality of the semiconductor memories in parallel, and is configured to be able to perform an interleave operation, the interleave operation performing a first operation to one semiconductor memory of the plurality of the semiconductor memories while performing a second operation to a semiconductor memory other than the one semiconductor memory, and when the first operation is finished, performing the first operation to another semiconductor memory of the plurality of the semiconductor memories while performing a second operation to a semiconductor memory other than the another semiconductor memory,
the control circuit performs the first operation to the plurality of the semiconductor memories in parallel when the difference between the first terminal voltage and the second terminal voltage is smaller than the certain value, and operates the plurality of the semiconductor memories by the interleave operation when the difference between the first terminal voltage and the second terminal voltage is larger than the certain value.

18. The control system of the semiconductor memory according to claim 15, wherein,
the control circuit controls the semiconductor memory via a memory interface and performs a control so as to decrease a drive frequency of the memory interface when the difference between the first terminal voltage and the second terminal voltage is larger than the certain value.

19. The control system of the semiconductor memory according to claim 15, wherein,
the control circuit performs a control so as to decrease a drive frequency of the control circuit when the difference between the first terminal voltage and the second terminal voltage is larger than the certain value.

20. The control system of the semiconductor memory according to claim 15, wherein,
the control circuit further controls a displaying device, and performs a control so as to input a certain signal to the displaying device when the difference between the first terminal voltage and the second terminal voltage is larger than the certain value.
